(19) United States
(12) Patent Application Publication
(10) Pub. No.: US 2026/0146132 A1
(43) Pub. Date: May 28, 2026

(54) METHOD FOR INTERFACIAL CHAIN-GROWTH POLYMERIZATION AND ULTRA-HIGH MOLECULAR WEIGHT POLYMER

(71) Applicant: Changchun Institute of Applied Chemistry Chinese Academy of Sciences, Changchun City (CN)

(72) Inventors: Youhua TAO, Changchun City (CN); Yanchao WANG, Changchun City (CN); Jinlong CHEN, Changchun City (CN)

(21) Appl. No.: 19/326,242

(22) Filed: Sep. 11, 2025

(30) Foreign Application Priority Data
Nov. 28, 2024 (CN) 202411726056.5

(51) Int. Cl. C08G 75/26; C08J 11/28

(52) U.S. Cl. CPC C08G 75/26; C08J 11/28; C08J 2381/00

(57) ABSTRACT

The present disclosure discloses a novel method for interfacial chain-growth polymerization and an ultra-high molecular weight polymer. The present disclosure pertains to the technical field of preparing an ultra-high molecular weight polymer. The novel method for interfacial chain-growth polymerization comprising steps of: mixing a combined catalyst of an organic base and a hydrogen bond donor, an initiator, a monomer to carry out the interfacial chain-growth polymerization; wherein the monomer is selected from a lactide, a lactone, a thiolactone, a lactam, an acrylate or an olefin; the initiator is one or more selected from the group consisting of alcohol-based substances and thiol-based substances; and the hydrogen bond donor is selected from a structure represented by Formula 1 or a structure represented by Formula 2. The novel method effectively suppresses polymerization side reactions through phase separation of the polymer chains from the solvent, thereby obtaining an ultra-high molecular weight polymer. The poly(thioglycolide) of the ultra-high molecular weight polymer has good thermal and mechanical properties, and excellent barrier property, especially outstanding oxygen barrier property. Also, the poly(thioglycolide) can be recycled by solution depolymerization.

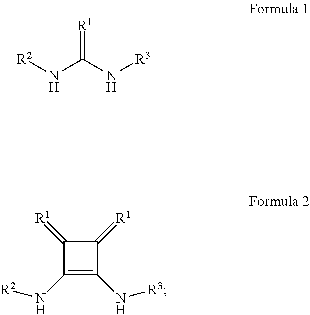

### TECHNICAL FIELD

The present disclosure pertains to the technical field of preparing an ultra-high molecular weight polymer, and particularly to a method for interfacial chain-growth polymerization and an ultra-high molecular weight polymer.

### BACKGROUND

Large scale use and disposal of plastic materials result in severe resource waste and environmental pollution. How to deal with plastic waste economically and environmentally friendly has become a globally urgent issue. Closed-loop recyclable plastic materials can be directly converted from polymer materials into original monomers after use, achieving resource recycling and same-level use. This is an effective approach to fundamentally solve the issue of plastic waste disposal.

Although some closed-loop recyclable polymers have been reported, which can achieve the closed-loop cycle of monomer-polymer-monomer, there is still a problem of contradiction between the recyclability and the mechanical properties. That is, the closed-loop recyclable polymers generally have poor mechanical properties, which are difficult to meet the requirements for practical applications. The molecular weight of a polymer directly affects its properties. It is an effective solution to the problem of contradiction between the recyclability and the mechanical properties of the closed-loop recyclable polymers to improve the mechanical properties of the polymers by increasing their molecular weights.

Polythioesters are a class of potential closed-loop recyclable polymers, and have relatively weak thioester bond, thereby easily achieving a balance between polymerization and depolymerization. However, side reactions such as transthioesterification and back biting reactions are likely to occur during polymerization, making it difficult to obtain polythioester materials having high molecular weight, which limits the application to some extent. In CN Patent Application No. 202110213868.X, an organic base alone is used as a catalyst for solution polymerization, where there is vigorous transthioesterification, with poor polymerization controllability and low molecular weight. It is reported in Article, Angew. Chem. Int. Ed. 2021, 60, 22547 that an organic base alone is used as a catalyst for solution polymerization, where there is vigorous transthioesterification reaction during polymerization, with poor polymerization controllability and unsatisfactory molecular weight. It is reported in Article, Polymer 2021, 215, 123386 that a conventional organic base is used for experiments of homopolymerization and copolymerization with other monomers, and only low molecular weight polymers having poor thermodynamic stability and mechanical properties, are synthesized, which limits their practical application. It is reported in Article, Macromolecules 2015, 48, 5481-5486 that DBU and thiourea catalyze solution ring-opening polymerization of thiocaprolactone, only resulting in medium molecular weight polythioesters with a molecular weight less than 35000.

Therefore, it is a technical challenge to be urgently addressed at present to study and develop an efficient catalyst and a polymerization method for suppressing side reactions during polymerization and synthesizing a high molecular weight recyclable polythioester material.

### SUMMARY

In view of this, the technical problem to be overcome by the present invention is to provide a novel method for interfacial chain-growth polymerization and an ultra-high molecular weight polymer. The novel method for interfacial chain-growth polymerization achieves the synthesis of an ultra-high molecular weight polymer by effectively suppressing intra-chain and inter-chain side reactions occurred during the polymer synthesis.

In order to arrive at the above objective, embodiments of the present disclosure are as follows.

The present disclosure provides a novel method for interfacial chain-growth polymerization, comprising steps of:
mixing a combined catalyst of an organic base and a hydrogen bond donor, an initiator, and a monomer to carry out an interfacial chain-growth polymerization;
wherein the monomer is selected from a lactide, a lactone, a thiolactone, a lactam, an acrylate or an olefin;
the initiator is one or more selected from the group consisting of alcohol-based substances and thiol-based substances;
the hydrogen bond donor is selected from a structure represented by Formula 1 or a structure represented by Formula 2:

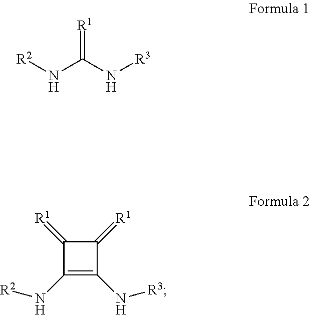

wherein R¹ is selected from O, S or Se;
R² and R³ are one or more independently selected from the group consisting of hydrogen, a C₁₋₃₀ perfluoroalkyl, a C₁₋₃₀ linear or branched aliphatic alkyl, a substituted or unsubstituted C₁₋₃₀ cycloaliphatic hydrocarbyl, a substituted or unsubstituted C₆₋₃₀ aryl, a C₂₋₃₀ alkenyl, a C₂₋₃₀ alkynyl, a C₃₋₃₀ heterocyclic group, and a substituted or unsubstituted C₅₋₃₀ heteroaryl; and
a substituent of the substituted C₆₋₃₀ aryl or a substituent of the substituted C₅₋₃₀ heteroaryl is one or more independently selected from the group consisting of trifluoromethyl, a nitrile group, a nitro group, and a halogen.

In the present disclosure, more preferably, R² and R³ are one or more independently selected from the group consisting of:

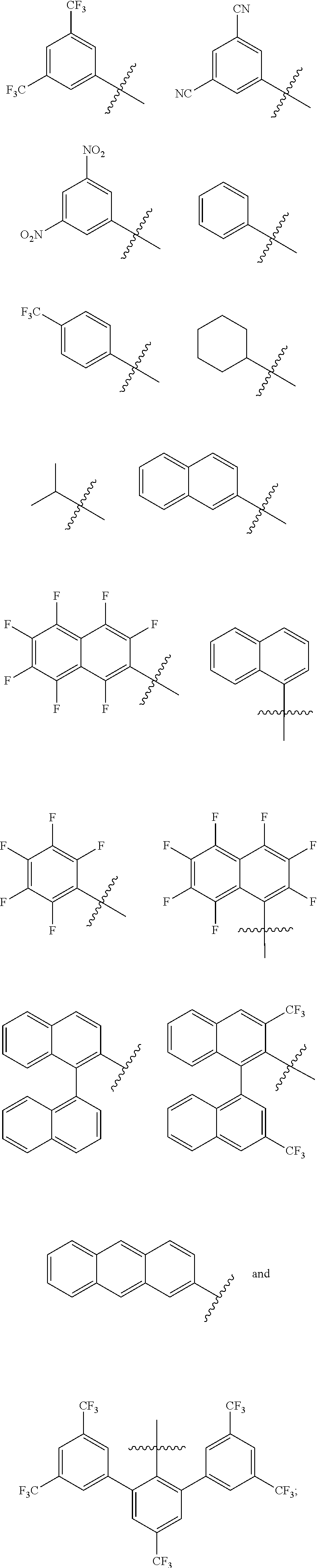

wherein/represents a linking position.

In the present disclosure, further preferably, the hydrogen bond donor is any structure selected from the group consisting of:

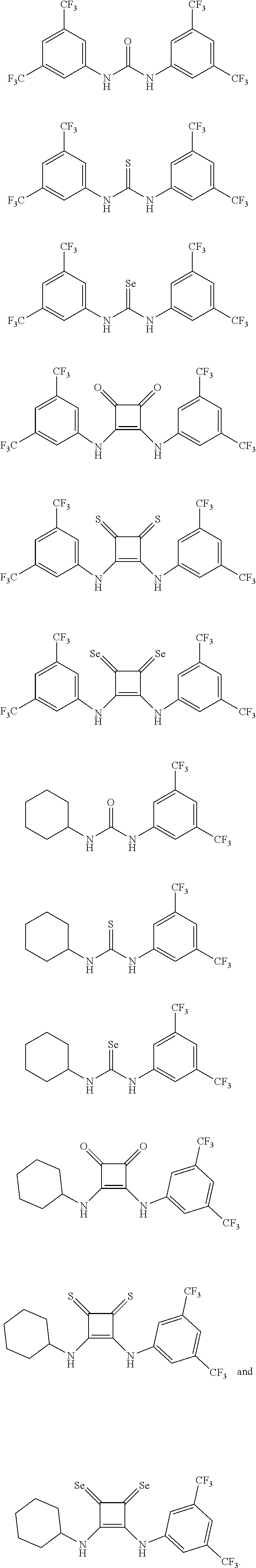

During the novel method for interfacial chain-growth polymerization of the present disclosure, when the polymer chains grow to a critical chain length, their solubility will decrease, and they will precipitate from the solution. However, due to the activation by the combined catalyst of the organic base and the hydrogen bond donor, the ends of the polymer chains will be still dissolved in the solution, and continue to undergo polymerization with the monomers in the solution at the solid/liquid interface, such that the polymer chains are separated from the solvent through solid-liquid phase separation, and are free from the polymerization system, which can effectively suppress intra-chain and inter-chain side reactions during polymerization, thereby obtaining ultra-high molecular weight polymers. This polymerization principle of the interfacial chain-growth polymerization of the present application described above may be schematically illustrated in FIG. 7.

In the novel method for interfacial chain-growth polymerization as described above, the organic base and the hydrogen bond donor of the combined catalyst catalyze synergistically to suppress side reactions during polymerization and increase the solubility of the ends of the polymer chains in the monomer solution phase, thereby facilitating the continued progress of the interfacial chain-growth polymerization.

In the novel method for interfacial chain-growth polymerization of the present disclosure, polymers will also precipitate when a certain polymerization degree is achieved, but the ends of the polymer chains has solubility in the solution phase containing the monomer and the catalyst, and the precipitation of the polymers will not result in the termination of the polymerization, such that the polymerization can continuously proceed at the interface between the monomer solution and the solid polymer. Also, since the ends of the growing polymer chains are phase separated from the polymer bulk (the solid phase), the probability of attacking the functional groups on the polymer chains can be reduced, thereby reducing the occurrence of side reactions and facilitating the interfacial chain-growth polymerization.

In the present disclosure, preferably, the organic base is one or more selected from the group consisting of 4-dimethylaminopyridine, DBU, TBD, tBuP₂, sodium thiophenolate, and triethylamine.

Preferably, the initiator is selected from the group consisting of benzyl alcohol, methanol, ethanol, benzyl mercaptan, 1,4-benzenedithiol, an alkylthiol having 1-20 carbon atoms, and thiophenol.

In the present disclosure, preferably, a molar ratio of the organic base to the hydrogen bond donor is in a range from 1:0.5 to 1:5.

Preferably, a molar ratio of the monomer to the initiator is in a range from 1000:1 to 20000:1.

Preferably, a molar ratio of the combined catalyst of the organic base and the hydrogen bond donor to the initiator is in a range from 0.01:1 to 1:1; more preferably in a range from 0.01:1 to 0.1:1; and is 0.02:1 in some particular embodiments of the present disclosure.

Preferably, a concentration of the monomer is 4-8 mol/L, and is 6 mol/L in some particular embodiments of the present disclosure.

In the present disclosure, preferably, the lactide is selected from dilactide or glycolide.

Preferably, the lactone is selected from propiolactone, valerolactone or caprolactone.

Preferably, the thiolactone is selected from thiodilactide, thioglycolide, thiopropiolactone or thiocaprolactone.

Preferably, the lactam is selected from caprolactam and propiolactam.

Preferably, the acrylate is selected from methyl methacrylate.

Preferably, the olefin is selected from styrene.

Accordingly, the following structures are shown:

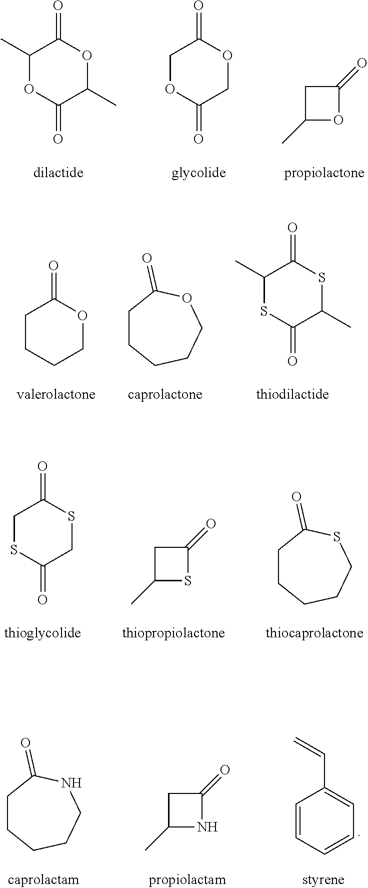

In the present disclosure, preferably, the interfacial chain-growth polymerization is performed at a temperature of −20° C. to 80° C.

The interfacial chain-growth polymerization is preferably performed for 0.1-48 h.

A solvent for the interfacial chain-growth polymerization is one or more selected from the group consisting of chloroform, toluene, n-hexane, petroleum ether, dichloromethane, dioxane, tetrahydrofuran, and dimethylsulfoxide.

After the completion of the above interfacial chain-growth polymerization, the method further comprises a post-treatment process such as quenching and separation.

The quenching is preferably performed by using a mixed solution of trifluoroacetic acid/dichloromethane.

The separation is preferably suction filtration or centrifugation.

The present disclosure further provides an ultra-high molecular weight polymer obtained by the novel method for interfacial chain-growth polymerization as described above, wherein a monomer for the ultra-high molecular weight polymer is selected from a lactide, a lactone, a thiolactone, a lactam, an acrylate or an olefin.

The preferred examples for the lactide, the lactone, the thiolactone, the lactam, the acrylate and the olefin are the same as those described above, and will not be reiterated here.

In the present disclosure, preferably, when the thiolactone is selected from thioglycolide, the ultra-high molecular weight polymer is poly(thioglycolide) having a weight average molecular weight greater than 500 kg/mol. In some particular embodiments of the present disclosure, the poly(thioglycolide) has a weight average molecular weight of 501.3 kg/mol, 700.5 kg/mol, 505.2 kg/mol, 500.1 kg/mol, 504.1 kg/mol, 501.8 kg/mol, 505.1 kg/mol, or 502.1 kg/mol.

The poly(thioglycolide) of the present disclosure has good thermal and mechanical properties, which properties are comparable to isotactic polypropylene (iPP), and has higher tensile strength and toughness. Meanwhile, the poly(thioglycolide) also exhibits an outstanding steam barrier property, and has a steam transmission rate comparable to that of low density polyethylene, which can reach 0.95 g mm m⁻² day⁻¹, much less than that of the degradable polylactic acid polymer (8.6 g mm m⁻² day⁻¹). Furthermore, it also has an outstanding oxygen barrier property, with an oxygen permeability of 0.0027 Barrer. The oxygen barrier property of the poly(thioglycolide) is 30 times greater than that of the conventional beverage package material PET (polyethylene terephthalate), 100 times greater than that of the degradable plastic polylactic acid, 400 times greater than that of the isotactic polypropylene, and 1000 times greater than that of the low density polyethylene.

In the present disclosure, preferably, the poly(thioglycolide) is subjected to a solution depolymerization under an alkaline condition to obtain a thioglycolide monomer.

Preferably, the solution depolymerization is performed at a temperature of 25° C. to 100° C.; more preferably of 40° C. to 70° C.; and is 60° C. in some embodiments of the present disclosure.

The method as described above can achieve the closed-loop cycle by recycling the thioglycolide monomer through solution depolymerization. The recycling method is simple, low cost, and suitable for large scale industrial production. In the present disclosure, preferably, the alkaline condition is provided by one or more selected from the group consisting of 4-dimethylaminopyridine, triethylamine, pyridine, N,N-diisopropylethylamine, sodium hydroxide, and sodium thiophenolate; more preferably by sodium thiophenolate or 4-dimethylaminopyridine; and further preferably by sodium thiophenolate.

Preferably, a solvent for the solution depolymerization is one or more selected from the group consisting of chloroform, toluene, dichloromethane, dioxane, tetrahydrofuran, and dimethylsulfoxide; and more preferably is chloroform, tetrahydrofuran, or dimethylsulfoxide. In some particular embodiments of the present disclosure, dimethylsulfoxide (DMSO) is used.

As compared to prior art, the novel method for interfacial chain-growth polymerization provided by the present disclosure comprises steps of:
mixing a combined catalyst of an organic base and a hydrogen bond donor, an initiator, and a monomer to carry out the interfacial chain-growth polymerization; wherein the monomer is selected from a lactide, a lactone, a thiolactone, a lactam, an acrylate or an olefin; the initiator is one or more selected from the group consisting of alcohol-based substances and thiol-based substances; the hydrogen bond donor is selected from a structure represented by Formula 1 or a structure represented by Formula 2, wherein R¹ is selected from O, S or Se; R² and R³ are one or more independently selected from the group consisting of hydrogen, a C₁₋₃₀ perfluoroalkyl, a C₁₋₃₀ linear or branched aliphatic alkyl, a substituted or unsubstituted C₁₋₃₀ cycloaliphatic hydrocarbyl, a substituted or unsubstituted C₆₋₃₀ aryl, a C₂₋₃₀ alkenyl, a C₂₋₃₀ alkynyl, a C₃₋₃₀ heterocyclic group, and a substituted or unsubstituted C₅₋₃₀ heteroaryl; and a substituent of the substituted C₆₋₃₀ aryl or a substituent of the substituted C₅₋₃₀ heteroaryl is one or more independently selected from the group consisting of trifluoromethyl, a nitrile group, a nitro group, and a halogen. The novel method effectively suppresses polymerization side reactions through phase separation of the polymer chains from the solvent, thereby obtaining an ultra-high molecular weight polymer. The poly(thioglycolide) of the ultra-high molecular weight polymer has good thermal and mechanical properties, and excellent barrier property, especially outstanding oxygen barrier property. Also, the poly(thioglycolide) can be recycled through solution depolymerization, which breaks through the problem of poor steam barrier property of conventional degradable materials. This will effectively promote the application of the polythioester materials in the industry of closed-loop recyclable plastic materials.

### BRIEF DESCRIPTION OF DRAWINGS

FIG. 1 is a H¹-NMR spectrum for the poly(thioglycolide) prepared in Example 1;

FIG. 2 is a C¹³-NMR spectrum for the poly(thioglycolide) prepared in Example 1;

FIG. 3 shows dumbbell-shaped test pieces obtained by hot pressing the poly(thioglycolide) material prepared in Example 1 into a film at 175° C. and then cutting the film into dumbbell-shape;

FIG. 4 shows bottles obtained by single screw melt extruding the ultra-high molecular weight poly(thioglycolide) prepared in Example 1 at a temperature of 165° C. and then blow molding it;

FIG. 5 shows a filament produced by melt spinning the ultra-high molecular weight poly(thioglycolide) prepared in Example 1 at a temperature of 175° C.;

FIG. 6 shows a 3D printed red cup obtained by a fused additive manufacturing at a nozzle temperature of 200° C. with the ultra-high molecular weight poly(thioglycolide) prepared in Example 1; and

FIG. 7 schematically illustrates the polymerization principle of the interfacial chain-growth polymerization of the present application.

### DETAILED DESCRIPTION

In order to further illustrate the present disclosure, the novel method for interfacial chain-growth polymerization and the ultra-high molecular weight polymer provided in the present disclosure will be described in detail below with reference to examples.

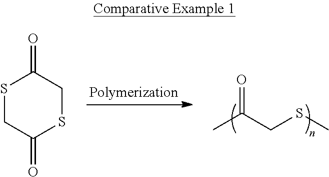

10 equivalents of 4-dimethylaminopyridine as a catalyst and 1 equivalent of benzyl mercaptane as an initiator were weighed respectively in a glove box. About 20000 equivalents of thioglycolide as a monomer was weighed and placed into a reactor (the reactor had been evacuated, baked with fire, cooled, and filled with nitrogen in advance, and the above procedure had been repeated three times), and then the weighed catalyst and initiator were added and then a solvent was added to carry out a solution polymerization, where the concentration of the monomer was 2 mol/L, and the molar ratio of monomer/initiator/catalyst was 20000/1/10. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=19.5 kg/mol and M_{w}/Mₙ=3.5. ¹H NMR (500 MHz, CDCl₃): δ 4.12 (1H). ¹³C NMR (125 MHz, CDCl₃): δ 193.13, 39.14.

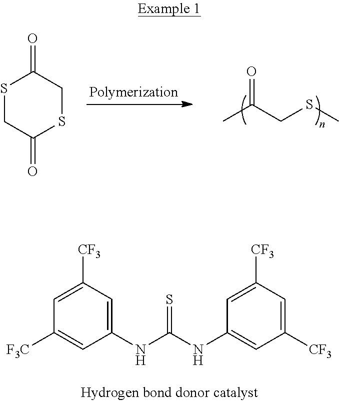

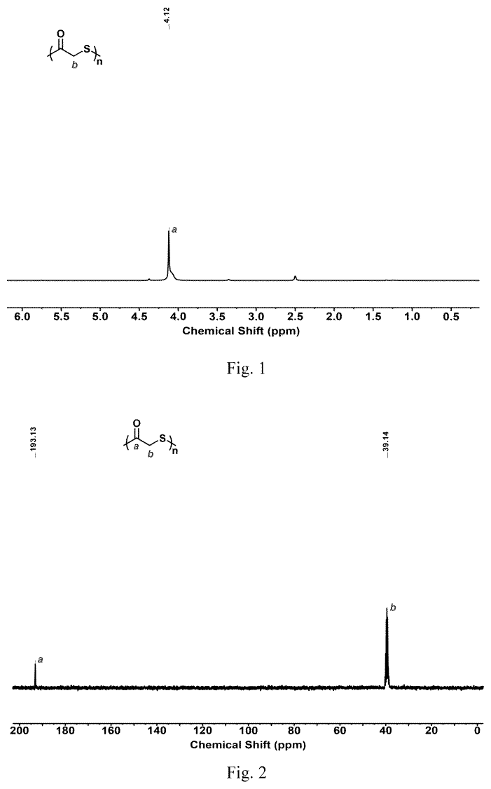

50 equivalents of 4-dimethylaminopyridine and 50 equivalents of TU1, as catalysts, and 1 equivalent of benzyl mercaptane as an initiator were respectively weighed in a glove box. About 20000 equivalents of a monomer of thioglycolide was weighed and placed into a reactor (the reactor had been evacuated, baked with fire, cooled, and filled with nitrogen in advance, and the above procedure had been repeated three times), and then the weighed catalyst and initiator were added and then dioxane was added to carry out an interface polymerization at 25° C., where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=501.3 kg/mol and M_{w}/Mₙ=4.6. ¹H NMR (500 MHz, CDCl₃) in FIG. 1: δ 4.12 (1H). ¹³C NMR (125 MHz, CDCl₃) in FIG. 2: δ 193.13, 39.14.

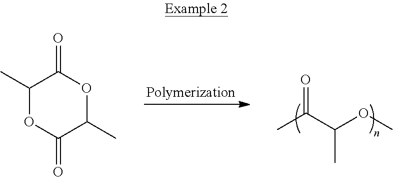

50 equivalents of DBU and 50 equivalents of TU1, as catalysts, and 1 equivalent of an initiator were respectively weighed in a glove box. About 20000 equivalents of thioglycolide as a monomer was weighed and placed into a reactor (the reactor had been evacuated, baked with fire, cooled, and filled with nitrogen in advance, and the above procedure had been repeated three times), and then the weighed catalyst and initiator were added and then toluene was added to carry out an interface polymerization at 25° C., where the concentration of the monomer was 2 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by analysis through GPC, obtaining M_{w}=700.5 kg/mol and M_{w}/Mₙ=1.56. ¹H NMR (500 MHz, CDCl₃): δ 5.24 (1H), 1.56 (3H).

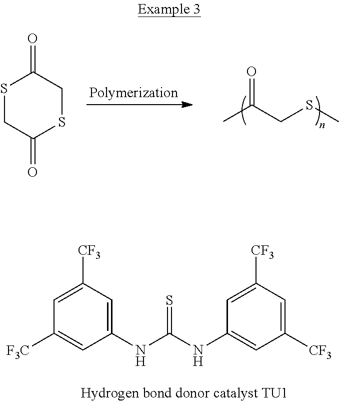

1 equivalent of 4-dimethylaminopyridine and 1 equivalent of TU1, as catalysts, and 1 equivalent of benzyl mercaptane as an initiator were respectively weighed in a glove box. About 20000 equivalents of thioglycolide as a monomer was weighed and placed into a reactor (the reactor had been evacuated, baked with fire, cooled, and filled with nitrogen in advance, and the above procedure had been repeated three times), and then the weighed catalyst and initiator were added and then dioxane was added to carry out an interface polymerization at 50° C., where the concentration of the monomer was 6 mol/L, and the molar ratio of monomer/initiator/catalyst was 20000/1/1. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=505.2 kg/mol and M_{w}/Mₙ=4.0.

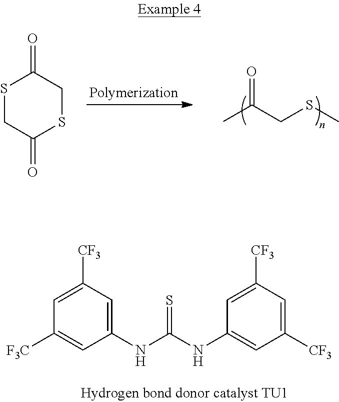

50 equivalents of TBD and 50 equivalents of TU1 (thiourea), as catalysts, and 1 equivalent of benzyl mercaptane as an initiator were respectively weighed in a glove box. About 20000 equivalents of thioglycolide as a monomer was weighed and placed into a reactor (the reactor had been evacuated, baked with fire, cooled, and filled with nitrogen in advance, and the above procedure had been repeated three times), and then the weighed catalyst and initiator were added and then dichloromethane was added to carry out an interface polymerization at 50° C., where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=500.1 kg/mol and M_{w}/Mₙ=4.7.

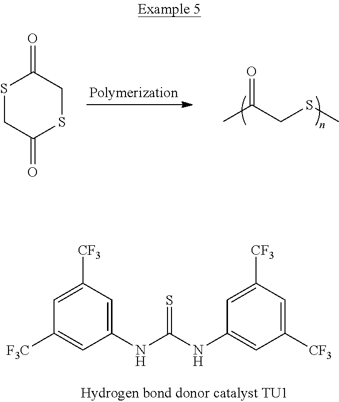

50 equivalents of sodium thiophenolate and 50 equivalents of TU1, as catalysts, and 1 equivalent of benzyl mercaptane as an initiator were respectively weighed in a glove box. About 20000 equivalents of thioglycolide as a monomer was weighed and placed into a reactor (the reactor had been evacuated, baked with fire, cooled, and filled with nitrogen in advance, and the above procedure had been repeated three times), and then the weighed catalyst and initiator were added and then dioxane was added to carry out an interface polymerization at 25° C., where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=504.1 kg/mol and M_{w}/Mₙ=4.7.

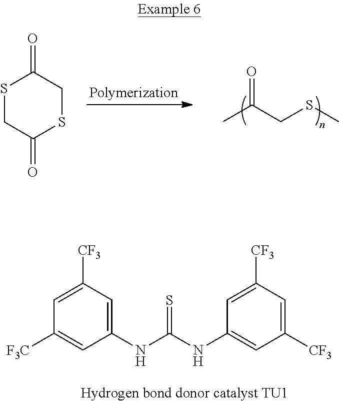

50 equivalents of triethylamine and 50 equivalents of TU1, as catalysts, and 1 equivalent of benzyl mercaptane as an initiator were respectively weighed in a glove box. About 20000 equivalents of a monomer of thioglycolide was weighed and placed into a reactor (the reactor had been evacuated, baked with fire, cooled, and filled with nitrogen in advance, and the above procedure had been repeated three times), and then the weighed catalyst and initiator were added and then dichloromethane was added to carry out an interface polymerization at 25° C., where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=501.8 kg/mol and M_{w}/Mₙ=4.7.

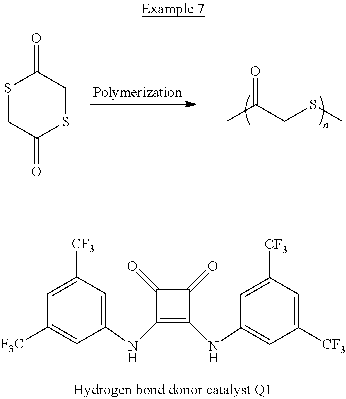

50 equivalents of DBU and 50 equivalents of Q1, as catalysts, and 1 equivalent of an initiator of benzyl mercaptane were respectively weighed in a glove box. About 20000 equivalents of a monomer of thioglycolide was weighed and placed into a reactor (the reactor had been evacuated, baked with fire, cooled, and filled with nitrogen in advance, and the above procedure had been repeated three times), and then the weighed catalyst and initiator were added and then a solvent was added to carry out an interface polymerization, where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=504.1 kg/mol and M_{w}/Mₙ=4.7.

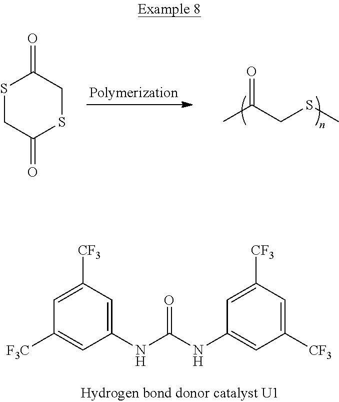

50 equivalents of DBU and 50 equivalents of U1, as catalysts, and 1 equivalent of an initiator of benzyl mercaptane were respectively weighed in a glove box. About 20000 equivalents of a monomer of thioglycolide was weighed and placed into a reactor (the reactor had been evacuated, baked with fire, cooled, and filled with nitrogen in advance, and the above procedure had been repeated three times), and then the weighed catalyst and initiator were added and then dioxane was added to carry out an interface polymerization at 50° C., where the concentration of the monomer was 6 mol/L, and the molar ratio of monomer/initiator/catalyst was 20000/1/50. Upon the polymerization was completed, the reaction was quenched with a trifluoroacetic acid/dichloromethane solution, and the reaction mixture was suction filtered to obtain a polymer. After drying for 24 hours, the molecular weight of the polymer was obtained by fitting and analysis through a Double reptation model, obtaining M_{w}=502.1 kg/mol and M_{w}/Mₙ=4.7.

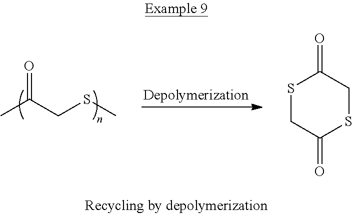

Specific processes are as follows:

50 mg of the poly(thioglycolide) material of Example 1 was dissolved in 0.5 mL DMSO, and 0.01 equivalents of sodium thiophenolate was added. The resultant mixture was reacted at 60° C. for 2 min. The reaction solution was monitored to confirm that the poly(thioglycolide) material was recycled as thioglycolide.

### Example 10

Specific processes for a barrier property test were as follows:

The polythioester material of Example 1 was hot pressed into a film at 175° C., and the film was cut into disc-shaped films with diameters of 5 cm and 10 cm for testing steam and oxygen barrier properties. The steam barrier property was determined by a steam barrier tester WVTR-255 under testing standard of GB/T 1037-2021, and the oxygen barrier property was determined by an oxygen barrier tester GTR-7003 under testing standard of GB/T1038. The steam barrier property was 0.95 g mm m⁻² day⁻¹, the oxygen barrier property was 0.0027 Barrer, and the carbon dioxide barrier property was 0.0095 Barrer (Table 1).

TABLE 1
Results for property test

| | | Comparative | | | | |
|---|---|---|---|---|---|---|
| Permeability | Example 1 | Example 1 | PLA | PET | iPP | LDPE |
| Steam | 0.95 | 2.8 | 3.6 | 1.46 | 0.70 | 0.78 |
| permeability | | | | | | |
| (g mm m⁻² | | | | | | |
| day⁻¹) | | | | | | |
| Oxygen | 0.0027 | 0.025 | 0.23 | 0.098 | 1.1 | 2.3 |
| permeability | | | | | | |
| (Barrer) | | | | | | |
| Carbon dioxide | 0.0095 | 0.012 | 1.1 | 0.53 | 3.6 | 6.5 |
| permeability | | | | | | |
| (Barrer) | | | | | | |

Notes:
in table 1, PLA represents polylactic acid, PET represents polyethylene terephthalate, iPP represents commercial isotactic polypropylene, and LDPE represents low density polyethylene.

### Example 11

Specific processes are as follows:

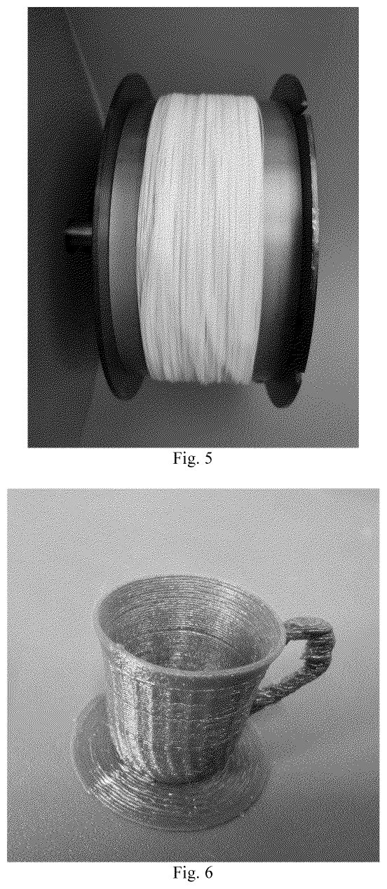

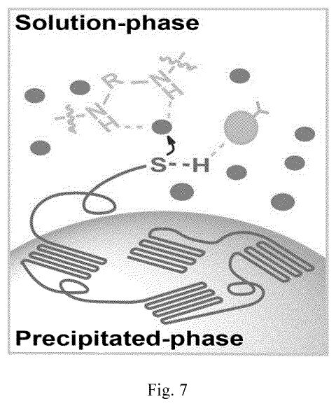

The ultra-high molecular weight poly(thioglycolide) prepared in Example 1 has a melt processability, and can be processed into a bottle by a single screw melt extruding procedure at a temperature of 165° C. and subsequent a blow molding procedure (as shown in FIG. 4). It can be melt spun at a temperature of 175° C. to produce a filament (as shown in FIG. 5). Finally, PTGA and polyethylene red color masterbatch were extruded together through a double screw extruder at 165° C. to produce a filament suitable for additive manufacture. A 3D printed red cup was obtained by a fused additive manufacturing at a nozzle temperature of 200° C. (as shown in FIG. 6), demonstrating that the material has a directly melt processability.

### Example 12

### Mechanical Property Test

Specific processes are as follows:

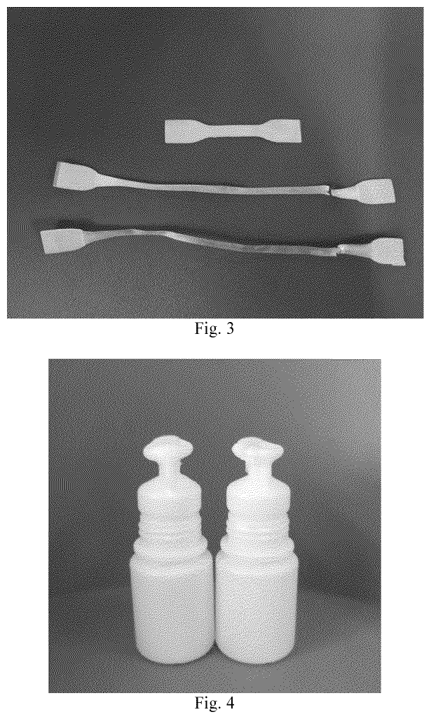

The poly(thioglycolide) material having a molecular weight of 19.5 kg/mol in Comparative Example 1 and the poly(thioglycolide) material having a molecular weight up to 504.1 kg/mol in Example 1 were hot pressed into films at 175° C., and the films were cut into dumbbell-shaped test pieces. The results for the poly(thioglycolide) having a molecular weight of 19.5 kg/mol are as follows: tensile strength σb=20.16 MPa, Elongation at break εb=8.6%; and the results for the poly(thioglycolide) having a molecular weight of 501.3 kg/mol are as follows: tensile strength σb=36.15 MPa, Elongation at break εb=464.2% (see table 2 and FIG. 3 for the property test). The mechanical property was determined by a mechanical properties testing instrument model Zwiek/Z010 under standard GB/T 1040-2018.

TABLE 2
Results for mechanical property test

| | | Comparative | | |
|---|---|---|---|---|
| Mechanical property | Example 1 | Example 1 | iPP | LDPE |
| Tensile strength (MPa) | 36.15 | 20.16 | 30.8 | 8.8 |
| Elongation at break (%) | 464.2 | 8.6 | 475.2 | 231.1 |

The above description of Examples is only intended to assist in understanding the method and concept of the present disclosure. It should be noted that some modifications and variations can be made to the present disclosure by a person skilled in the art without departing from the principle of the present invention. These modifications and variations also fall within the protection scope of the claims of the present invention.

What is claimed is:

1. A method for interfacial chain-growth polymerization, comprising steps of:
mixing a combined catalyst of an organic base and a hydrogen bond donor, an initiator, and a monomer to carry out the interfacial chain-growth polymerization;
wherein the monomer is selected from a lactide, a lactone, a thiolactone, a lactam, an acrylate or an olefin;
the initiator is one or more selected from the group consisting of alcohol-based substances and thiol-based substances;
the hydrogen bond donor is selected from a structure represented by Formula 1 or a structure represented by Formula 2: 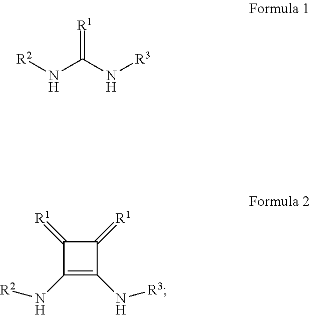
wherein R¹ is selected from O, S or Se;
R² and R³ are one or more independently selected from the group consisting of hydrogen, a C₁₋₃₀ perfluoroalkyl, a C₁₋₃₀ linear or branched aliphatic alkyl, a substituted or unsubstituted C₁₋₃₀ cycloaliphatic hydrocarbyl, a substituted or unsubstituted C₆₋₃₀ aryl, a C₂₋₃₀ alkenyl, a C₂₋₃₀ alkynyl, a C₃₋₃₀ heterocyclic group, and a substituted or unsubstituted C₅₋₃₀ heteroaryl; and
a substituent of the substituted C₆₋₃₀ aryl or a substituent of the substituted C₅₋₃₀ heteroaryl is one or more independently selected from the group consisting of trifluoromethyl, a nitrile group, a nitro group, and a halogen.

2. The method for interfacial chain-growth polymerization according to claim 1, wherein R² and R³ are one or more independently selected from the group consisting of: 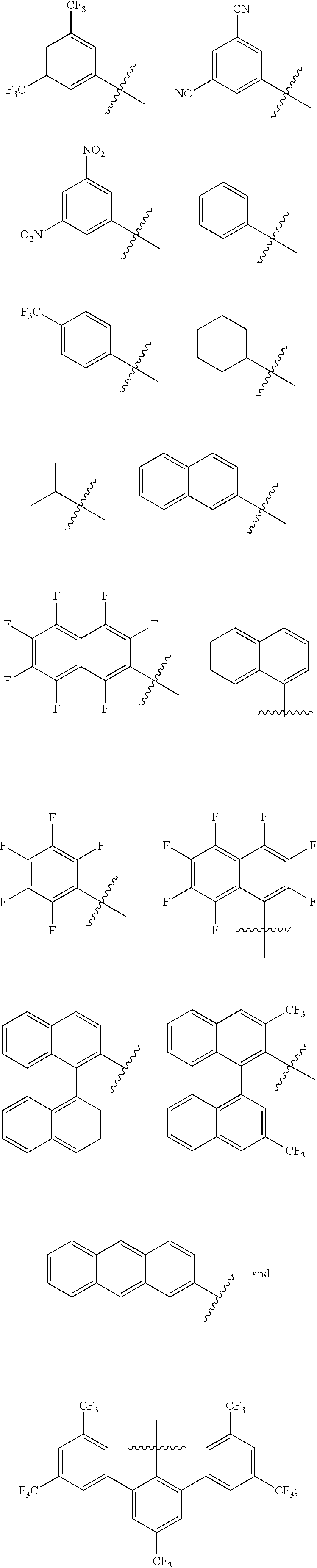
wherein/represents a linking position.

3. The method for interfacial chain-growth polymerization according to claim 1, wherein the hydrogen bond donor is any one structure selected from the group consisting of:

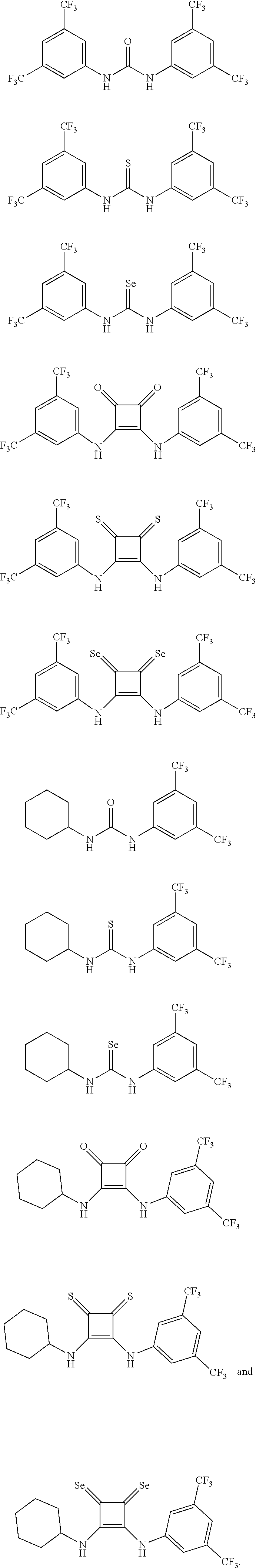

4. The method for interfacial chain-growth polymerization according to claim 1, wherein the organic base is one or more selected from the group consisting of 4-dimethylaminopyridine, DBU, TBD, t-BuP₂, sodium thiophenolate, and triethylamine; and
the initiator is selected from benzyl alcohol, methanol, ethanol, benzyl mercaptan, 1,4-benzenedithiol, an alkylthiol having 1-20 carbon atoms, or thiophenol.

5. The method for interfacial chain-growth polymerization according to claim 1, wherein a molar ratio of the organic base to the hydrogen bond donor is in a range from 1:0.5 to 1:5;
a molar ratio of the monomer to the initiator is in a range from 1000:1 to 20000:1;
a molar ratio of the combined catalyst of the organic base and the hydrogen bond donor to the initiator is in a range from 0.01:1 to 1:1; and
a concentration of the monomer is 4-8 mol/L.

6. The method for interfacial chain-growth polymerization according to claim 1, wherein the lactide is selected from dilactide or glycolide;
the lactone is selected from propiolactone, valerolactone or caprolactone;
the thiolactone is selected from thiodilactide, thioglycolide, thiopropiolactone or thiocaprolactone;
the lactam is selected from caprolactam or propiolactam;
the acrylate is selected from methyl methacrylate; and
the olefin is selected from styrene.

7. The method for interfacial chain-growth polymerization according to claim 1, wherein the interfacial chain-growth polymerization is performed at a temperature of −20° C. to 80° C.; and
a solvent for the interfacial chain-growth polymerization is one or more selected from the group consisting of chloroform, toluene, n-hexane, petroleum ether, dichloromethane, dioxane, tetrahydrofuran, and dimethylsulfoxide.

8. An ultra-high molecular weight polymer obtained by the method for interfacial chain-growth polymerization according to claim 1,
wherein a monomer for the ultra-high molecular weight polymer is selected from a lactide, a lactone, a thiolactone, a lactam, an acrylate or an olefin.

9. The ultra-high molecular weight polymer according to claim 8, wherein the thiolactone is thioglycolide, and the ultra-high molecular weight polymer is poly(thioglycolide) having a weight average molecular weight of greater than 500 kg/mol.

10. The ultra-high molecular weight polymer according to claim 9, wherein the poly(thioglycolide) is subjected to a solution depolymerization under an alkaline condition to obtain a thioglycolide monomer; and
wherein the solution depolymerization is performed at a temperature of 25° C. to 100° C.
